(19) United States
(12) Patent Application Publication
(10) Pub. No.: US 2007/0152186 A1
(43) Pub. Date: Jul. 5, 2007

(54) Reactive oxygen detecting and/or absorbing compound, method for preparing said compound and a device comprising it

(75) Inventors: Claude Lapinte, Cesson-Sevigne (FR); Severine Roue, Ergue Gaberic (FR); Safaa Ibn Ghazala, Saint Gregoire (FR); Edmond Roussel, Danvou la Ferriere (FR); Marc Henri Legrand, Caen (FR)

Correspondence Address: BAKER & DANIELS LLP;111 E. WAYNE STREET, SUITE 800, FORT WAYNE, IN, 46802, US

(73) Assignees: UNIVERSITE DE RENNES 1, Rennes Cedex (FR); ATMOSPHERE CONTROLE, Bretteville sur Odon (FR)

(21) Appl. No.: 10/596,557

(22) PCT Filed: Dec. 15, 2004
(86) PCT No.: PCT/FR04/50697

§ 371 Date: Mar. 23, 2007

(30) Foreign Application Priority Data
Dec. 18, 2003 (FR) 0314868

(51) Int. Cl. C09K 3/00; C07F 15/00

(52) U.S. Cl. 252/184; 546/2

(57) ABSTRACT

The inventive reactive oxygen detecting and/or absorbing compound is characterised in that it consists of a complex molecular metallic (1)/ligand (2) derivatives which changes the colour thereof according to the oxydation degree of a metal and is connected to the surface of a solid support (3) by a covalent bond.

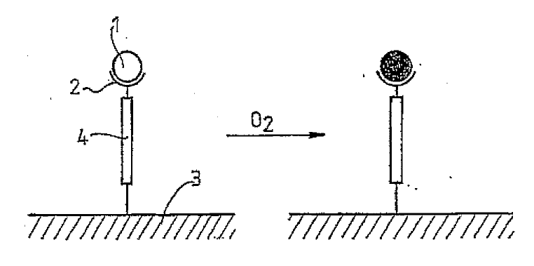

The present invention relates to a reactive compound which is capable of having two complementary functions, that is to say, on the one hand, detecting the presence of oxygen by means of a clear colour change which can be seen both with the naked eye and with a spectrophotometer and, on the other hand, chemically and irreversibly absorbing the oxygen contained in a closed chamber.

Systems for indicating oxygen have been extensively described in documentation; they generally use a colorant which changes shade in accordance with its level of oxidation associated with a reducing agent in order to maintain the reduced form of the colorant when no oxygen is present (documents DE-30 25 264, JP-62 183 834, WO-93/24820, WO-98/03866 . . . ).

The oxygen-indicating reagent may be in the form of ink (documents DE-30 25 264, JP-62 183 834), incorporated in a thermoplastic material (document WO-2003/00557), interposed between materials which are permeable to oxygen (document WO-93/24820) or incorporated in an amorphous medium (document FR-2 710 751).

Specialists have at the same time already proposed a wide range of oxygen-absorbing devices which are used within a number of technical fields, including, for example, food-processing industries, in particular for producing packagings which allow food products to be stored in an inert atmosphere, pharmaceutical industries, for the storage of preparations for medical use, or more generally in all fields which require an atmosphere which is free from oxygen or which has a low content of oxygen.

These different systems have one disadvantage in common, which is connected with the fact that the indicating and/or absorbing reagent is susceptible to migration phenomena, which can be very disruptive, in particular in the context of applications which are connected with the food or pharmaceutical industry.

In this context, the object of the present invention is to provide a reactive oxygen-detecting and/or -absorbing compound in which the indicating reagent is connected in an irreversible manner to a solid support so that it does not risk being exposed to migration phenomena, and which can further be obtained from non-toxic products which are commercially available.

This reactive compound is characterised in that it is constituted by a molecular complex which comprises a metal derivative/ligand which changes colour in accordance with the extent of oxidation of the metal and which is connected to the surface of a solid support by means of a covalent bond.

Owing to the fact that the active molecules of the reactive compound according to the invention are fixed to a support, thus constituting a hybrid material, they cannot migrate by means of contact into another substance.

According to the invention, the molecular complex is preferably connected to the surface of the support by means of a derivative of an organic linking chain.

A chain of this type comprises, on the one hand, a first function or grafting function which allows it to be fixed to the support and, on the other hand, a second function, or co-ordination function, which is suitable for bringing about coupling with an associated molecular condensation entity in order to form the ligand which allows the complexing of the metal derivative.

The appended drawing is a schematic illustration of the configuration of the reactive compound according to the invention and its colour change following a chemical reaction of the metal derivative which it contains with oxygen.

A reactive compound of this type is constituted by a complex which comprises a metal derivative 1/ligand 2 and which is connected to the surface of a support 3 by means of a derivative of an organic linking chain 4 which constitutes a branch which allows the functional portion 1, 2 of the reactive compound to be fixed to the support 3.

The reactive compound according to the invention is therefore constituted by an organic molecular complex which is sensitive to oxygen and which is fixed in a secure manner by means of covalent chemical bonds to the surface of a support which retains its mechanical properties but which takes on the colour of this complex, this colour being changed when it is exposed to an atmosphere which contains oxygen.

The rate of this colour change depends on the temperature and the partial pressure in terms of oxygen and the degree of humidity of the atmosphere in question.

Used alone or in combination with other oxygen-absorbing agents, this reactive compound allows the presence of oxygen to be detected and the oxygen present in a chamber to be absorbed.

According to the invention, the ligand may advantageously comprise a heteroatomic chain which may or may not be substituted and which comprises two conjugated imine functional groups and in which at least two atoms of nitrogen, one of which belongs to a pyridine core or the like, are separated by two atoms of carbon.

According to the invention, a core similar to a pyridine core may be, for example, a substituted pyridine core or a polycyclical system which contains at least one pyridine core.

According to a preferred feature of the invention, the coordination function of the organic linking chain is an amine function, in particular a primary amine function.

The molecular condensation entity may itself advantageously be constituted by 2-pyridine carboxaldehyde, 2-pyridine carboxylic acid or the chloride thereof.

According to this feature, the ligand is therefore constituted by a compound which results from the condensation of 2-pyridine carboxaldehyde, or 2-pyridine carboxylic acid or the chloride thereof, with the amine function of the organic linking chain.

A condensation of this type may lead to the formation of nitrogenous bidentate, tridentate or tetradentate ligands which are capable of complexing a number of transition metals and their derivatives.

Complexes of this type may, in the presence of oxygen, take on an intense colour which is characteristic of the extent of oxidation of the metal.

According to the invention, the metal derivative must be selected in such a manner that, at the centre thereof, the metal has a low level of oxidation and is therefore capable of reacting with oxygen.

By way of example, this metal derivative may advantageously be selected from the group formed by CuCl, [Cu(CH₃CN)₄] [PF₆], AgNO₃, and FeSO₄.

In the metal derivative [Cu(CH₃CN)₄] [PF₆], the counter-anion PF₆ may be replaced by any other weakly co-ordinating counter-anion, such as BF₄ or CF₃OSO₂.

According to a first variant of the invention, the support is an organic polymer support such as polystyrene balls or a co-polymer based on polystyrene, and the grafting function of the organic linking chain is an alkene function.

By way of example, the reactions below constitute three examples for preparing ligands L1, L2, L3 based on organic linking chains which are commercially available and which comprise, on the one hand, an alkene function which allows them to be fixed to an organic polymer support by means of co-polymerisation and, on the other hand, a primary amine function which is capable of reacting by means of condensation with 2-pyridine carboxaldehyde or 2-pyridine carboxylic acid.

The molecular complexes which are obtained after the ligand has reacted with a derivative of a transition metal have a strip for intense metal/ligand absorption in the visible range. The colour of this strip is often characteristic of the extent of oxidation of the metal.

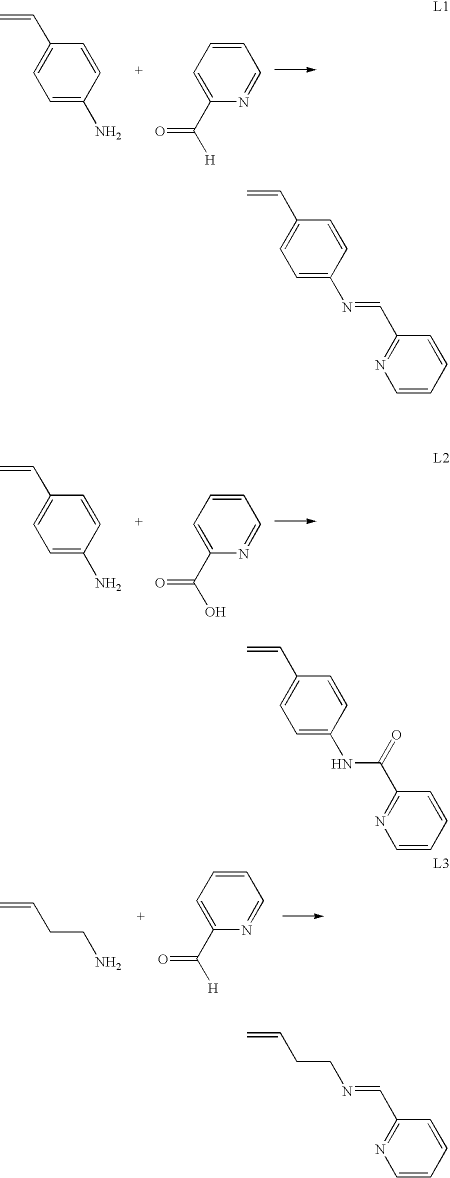

Furthermore, balls of functional polystyrene which have one or more primary amine functions and/or one or more secondary amine functions and which are commercially available may constitute a support which is simple to use.

According to a second variant of the invention, the support is a mineral support, such as balls of a mineral glass, and the grafting function of the organic linking chain is a trialkoxysilane function, in particular a trimethoxysilane function.

The support is preferably constituted by an activated metal oxide, such as TiO₂, ZrO₂ or preferably SiO₂ or Al₂O₃ which constitute inexpensive oxides which are completely non-toxic and which are also commercially available in a wide range of qualities.

A support of this type may advantageously be in the form of glass-like balls which may have different granulometries θ, by way of example, 60<θ<200 μm or 200<θ<500 μm.

According to this variant of the invention, the organic linking chain may itself advantageously be selected from the group formed by 3-aminopropyltrimethoxysilane, N-[3-(trimethoxysilyl) propyl]ethylenediamine and 3-(2-(2-amino) ethylamino]propyl-trimethoxysilane.

The invention also relates to a method for preparing a reactive compound of the type mentioned above which is connected to the surface of a mineral support.

According to the invention, a method of this type is characterised in that it comprises the following steps:
activating the support by means of immersion in an acid solution, washing operations, then air-drying,
grafting the organic linking chain to the activated support by means of immersion in ethanol at ambient temperature,
synthesis of the ligand in situ by adding the molecular condensation entity to the organic chain previously grafted to the support which may or may not have been activated at ambient temperature and in an ethanol medium, and
co-ordinating the metal derivative on the ligand or metallisation by means of immersion in a solution of ethanol at ambient temperature in an inert atmosphere.

It should be noted that the steps for grafting the organic linking chain to the activated support and for synthesis of the ligand in situ are inseparable and can be carried out in one sequence or the other, which means that the activated support can be introduced into the reaction medium before or after the molecular condensation entity.

The method according to the invention has the advantage of being able to be carried out in air, with the exception of the final step of metallisation which requires an inert atmosphere, although the reactive compound which is ultimately obtained is intended to react with oxygen.

In the embodiment in which the support is constituted by balls of silica and the organic chain by 3-aminopropyl trimethoxysilane, the grafting of the organic linking chain on the activated support and the synthesis of the ligand in situ may be illustrated as below:

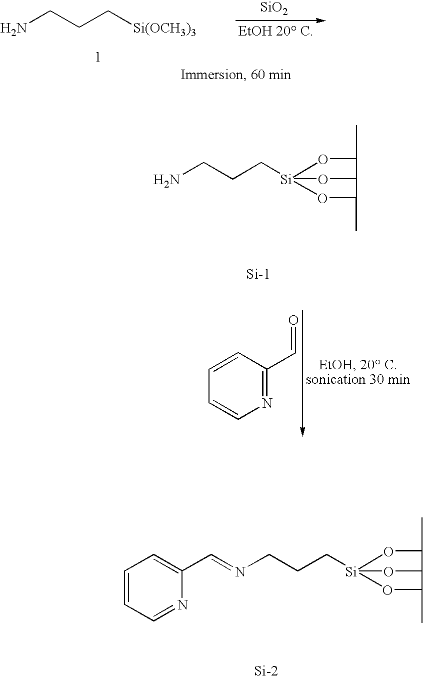

The method according to the invention thus allows an Si-1 chain to be obtained which is grafted to the support, then, after addition of 2-pyridine carboxaldehyde and agitation using an ultrasound bath (sonication), an Si-2 compound to be obtained which is constituted by the ligand which is grafted to the activated support by means of a derivative of the organic chain.

In the case of a metal derivative MLₙ, the final step of metallisation may itself be illustrated as below:

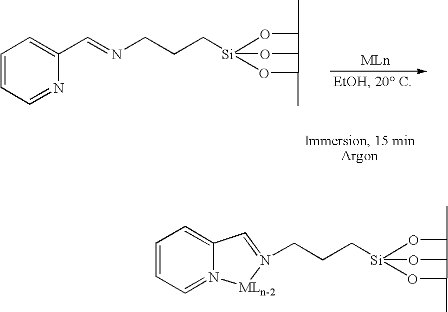

The Si-3 and Si-4 compounds illustrated below correspond to other examples of structures of grafted complexes according to the invention which are obtained from organic chains which are constituted by N-[3-(trimethoxysilyl)propyl]-ethylenediamine or 3-[2-(2-amino)ethylamino]propyl-trimethoxysilane.

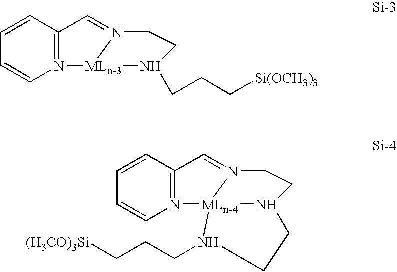

The various steps of the method according to the invention will be illustrated in greater detail by the following examples:

### EXAMPLE 1

### Activation of the Support

50 g (0.238 mole) of ammonium persulfate are gradually introduced into an Erlenmeyer flask containing one litre of 10 N sulphuric acid, with magnetic agitation. After cooling to 20° C., this solution is poured into a beaker containing 250 g of silica. After homogenisation, the silica is allowed to immerse for one hour. After Buechner filtration, the silica is rinsed 5 times with 100 ml of water and then 5 times with 100 ml of distilled water.

The silica which has been activated in this manner is dried in a vacuum at 20° C. for a minimum of 30 minutes, then at 120° C. in an oven for a minimum of three hours.

### EXAMPLE 2

### Grafting Reaction: Preparation of Si-2

In a beaker, 3-aminopropyltrimethoxysilane (186.5 μl, 1 mmole) is dissolved in an excess of ethanol (30 ml), then 1 g of activated fine silica is introduced directly into the reaction medium. The solution is left to rest at 20° C. for one hour. An equivalent of 2-pyridine carboxaldehyde (96.5 μl, 1 mmole) is then added to the solution and the reaction admixture is agitated using an ultrasound bath for 30 minutes.

Finally, the support is recovered by means of Buechner filtration and rinsed in ethanol (3 times 20 ml) then in ether (3 times 20 ml). The grafted silica is allowed to dry in a vacuum for 15 minutes at 20° C. Graft ratio: 0.82 mmole/g.

### EXAMPLE 3

### Grafting Reaction: Preparation of Si-2

In a beaker, 2-pyridine carboxaldehyde (96.5 μl, 1 mmole) is dissolved in ethanol (30 ml), then an equivalent of 3-amino-5-pyridinetrimethoxysilane (136.5 μl, 1 mmole) is added to the solution and the reaction admixture is left in a state of agitation for 30 minutes. The support is then introduced directly into the reaction medium. Two techniques are then used:
→ either the mixture is left to rest for 18 hours at 20° C. (immersion method),
→ or the mixture is agitated using an ultrasound bath for 30 minutes at 20° C.

After grafting, the support is filtered, rinsed in ethanol, (3 times 20 ml) then in ether (3 times 20 ml). It is finally dried in the open air for 30 minutes. It should be noted that the balls which are initially white take on a yellowish colour after grafting, which is characteristic of imine. Graft ratio: 0.79 mmole/g.

### EXAMPLE 4

### Metallisation Reaction of Si-2

In a Schlenck tube, at 20° C., the grafted ligand (1 g) is suspended in deaerated ethanol (30 ml), then CuCl (99 mg, 1 mmole) is introduced with a current of argon. The admixture is kept in a state of magnetic agitation for 15 minutes. After filtering and washing in ethanol, (3 times 10 ml), the support is isolated and dried in a vacuum (2 h 30 min, 20° C.) then conditioned in an inert atmosphere. Metallisation ratio: 0.76 mmole/g.

### EXAMPLE 5

### Metallisation Reaction of Si-2

In a Schlenck tube, at 20° C., the grafted ligand (0.200 g) is suspended in deaerated ethanol (10 ml), then [Cu(CH₃CN)₄] [PF₆] (0.074 g, 0.2 mmole) is introduced with a current of argon. The admixture is kept in a state of magnetic agitation for 15 minutes. After filtering and washing in ethanol, (3 times 10 ml), the support is isolated and dried in a vacuum (2 h 30 min, 20° C.) then conditioned in an inert atmosphere. Metallisation ratio: 0.80 mmole/g.

### EXAMPLE 6

### Metallisation Reaction of Si-2

In a Schlenck tube, at 20° C., the grafted ligand (0.200 g) is suspended in an admixture of water/deaerated ethanol (50:50, 20 ml), then FeSo₄ (0.056 g, 0.2 mmole) is introduced with a current of argon. The admixture is kept in a state of magnetic agitation for 15 minutes. After filtering and washing in ethanol (3 times 20 ml), the support is isolated and dried in a vacuum (2 h 30 min, 20° C.) then conditioned in an inert atmosphere. Metallisation ratio: undetermined.

### EXAMPLE 7

### Metallisation Reaction of Si-2

In a Schlenck tube, at 20° C., the grafted ligand (0.200 g) is suspended in deaerated ethanol (20 ml), then AgNO₃ (0.339 g, 0.2 mmole) is introduced with a current of argon. The admixture is kept in a state of magnetic agitation for 15 minutes. After filtering and washing in ethanol (3 times 20 ml), the support is isolated and dried in a vacuum (2 h 30 min, 20° C.), then conditioned in an inert atmosphere. Metallisation ratio: undetermined.

### EXAMPLE 8

### Grafting Reaction: Preparation of Si-3

In a beaker, at ambient temperature, 1.85 ml of N-(3-(trimethylsilyl)-propyl) ethylenediamine is dissolved in an excess of ethanol (approximately 150 ml) then 10 g of silica activated with the admixture are left to rest for one hour. 1 ml of 2-pyridine carboxylaldehyde is added to the solution and the reaction admixture is agitated using an ultrasound bath for 30 minutes. Finally, the support is isolated by means of Buechner filtration and rinsed in ethanol (3 times 20 ml), then in ether (3 times 20 ml). The grafted silica is dried in a vacuum for 15 minutes at 20° C. Graft ratio: 0.65 mmole/g.

### EXAMPLE 9

### Grafting Reaction: Preparation of Si-4

1.85 ml of 3-[2-(2-aminoethylamino)ethylamino]propyl-trimethoxysilane, 150 ml of ethanol and 10 g of activated silica are successively introduced into a beaker at 20° C. The admixture is left to rest for one hour. 1 ml of 2-pyridine carboxylaldehyde is then added to the solution and the reaction admixture is agitated using an ultrasound bath for 30 minutes. Finally, the support is recovered by means of Buechner filtration and rinsed in ethanol (3 times 20 ml), then in ether (3 times 20 ml). The grafted silica is dried in a vacuum for 15 minutes at 20° C. Grafting ratio: 0.60 mmole/g.

### EXAMPLE 10

### Metallisation Reaction of Si-3

In a Schlenck tube, at 20° C., the grafted ligand (1 g) is suspended in deaerated ethanol (30 ml), then CuCl (0.100 g) is introduced with a current of argon. The admixture is kept in a state of magnetic agitation for 15 minutes. After filtering and washing in ethanol (3 times 10 ml), the support is isolated then dried in a vacuum (2 h 30 min, 20° C.). Metallisation ratio: 0.80 mmole/g.

### EXAMPLE 11

### Metallisation Reaction of Si-3

In a Schlenck tube, at 20° C., the grafted ligand (1 g) is suspended in deaerated acetone (10 ml), then 0.373 g of [Cu(CH₃CN)₄] [PF₆] are introduced with a current of argon. The admixture is kept in a state of magnetic agitation for 15 minutes. After filtering and washing in ethanol (3 times 10 ml), the support is isolated and dried in a vacuum (2 h 30 min, 20° C.). Metallisation ratio: 0.68 mmole/g.

### EXAMPLE 12

### Metallisation Reaction of Si-4

In a Schlenck tube, at 20° C., the grafted ligand (1 g) is suspended in deaerated ethanol (30 ml), then CuCl (0.100 g) is introduced with a current of argon. The admixture is kept in a state of magnetic agitation for 15 minutes. After filtering and washing in ethanol (3 times 10 ml), the support is isolated and dried in a vacuum (2 h 30 min, 20° C.) then conditioned in an inert atmosphere. Metallisation ratio: 0.80 mmole/g.

### EXAMPLE 13

### Metallisation Reaction of Si-4

In a Schlenck tube, at 20° C., the grafted ligand (1 g) is suspended in deaerated acetone (10 ml), then 0.373 g of [Cu(CH₃CN)₄] [PF₆] are introduced with a current of argon. The admixture is kept in a state of magnetic agitation for 15 minutes. After filtering and washing in ethanol (3 times 10 ml), the support is isolated and dried in a vacuum (2 h 30 min, 20° C.). Metallisation ratio: 0.70 mmole/g.

The present invention also relates to an oxygen-detecting and/or -absorbing device which comprises a reactive compound of the above-mentioned type.

A device of this type may have various configurations without thereby departing from the scope of the invention and may, for example, be constituted by a printing ink in which the reactive compound is incorporated; it is thus possible to obtain oxychromic inks which change colour in contact with oxygen.

Inks of this type are suitable for being used in particular in the context of marketing or education.

This device may also be in the form of agents for absorbing oxygen or for indicating the presence of oxygen in which the reactive compound may be bonded to a support by means of an adhesive, or a binding agent having a controlled melting temperature (hot melt), or dispersed in a polymer then extruded, or integrated in a sachet, in porous systems or between films which are permeable to oxygen so as to be in the form of a label.

This device may also be in the form of packaging sheets which change colour when they are placed in contact with an atmosphere which contains gaseous oxygen.

1. Reactive oxygen-detecting and/or -absorbing compound, characterised in that
it is constituted by a molecular complex which comprises a metal derivative (1)/ligand (2) and which changes colour in accordance with the extent of oxidation of the metal and which is connected to the surface of a solid support (3) by means of a covalent bond.

2. Reactive compound according to claim 1, characterised in that
the molecular complex is connected to the surface of the support by means of a derivative (4) of an organic linking chain which comprises, on the one hand, a first function or grafting function which allows it to be fixed to the support and, on the other hand, a second function, or co-ordination function, which is suitable for bringing about coupling with an associated molecular condensation entity in order to form the ligand which allows the complexing of the metal derivative.

3. Reactive compound according to claim 2, characterised in that
the ligand comprises a heteroatomic chain which may or may not be substituted and which comprises two conjugated imine functional groups and in which at least two atoms of nitrogen, one of which belongs to a pyridine core or the like, are separated by two atoms of carbon.

4. Reactive compound according to claim 3, characterised in that
the co-ordination function of the organic linking chain is an amine function.

5. Reactive compound according to either claim 3 or claim 4, characterised in that
the molecular condensation entity is constituted by 2-pyridine carboxaldehyde, or 2-pyridine carboxylic acid or the chloride thereof.

6. Reactive compound according to any one of claims 1 to 5, characterised in that
the metal derivative is selected from the group formed by CuCl, [Cu(CH₃CN)₄] [PF₆], AgNO₃, and FeSO₄.

7. Reactive compound according to any one of claims 1 to 6, characterised in that
the support is an organic polymer support such as polystyrene balls or a co-polymer based on polystyrene, and the grafting function of the organic linking chain is an alkene function.

8. Reactive compound according to claim 7, characterised in that
the balls which constitute the support are balls of functional polystyrene which have one or more primary amine functions and/or one or more secondary amine functions.

9. Reactive compound according to any one of claims 1 to 6, characterised in that the support is a mineral support, such as balls of a mineral glass, and the grafting function of the organic linking chain is a trialkoxysilane function, in particular a trimethoxysilane function.

10. Reactive compound according to claim 9, characterised in that
the organic linking chain is selected from the group formed by 3-aminopropyltrimethoxysilane, N-[3-(trimethoxysilyl)-propyl]ethylenediamine and 3-(2-(2-amino)ethylamino]propyl-trimethoxysilane.

11. Reactive compound according to either claim 9 or claim 10, characterised in that
the support is constituted by an activated metal oxide such as TiO₂, ZrO₂ or preferably SiO₂ or Al₂O₃.

12. Method for preparing a reactive compound according to any one of claims 9 to 11, in which the support is a mineral support, characterised in that
it comprises the following steps:
− activating the support by means of immersion in an acid solution, washing operations, then air-drying,
− grafting the organic chain to the activated support by means of immersion in ethanol at ambient temperature,
− synthesis of the ligand in situ by adding the molecular condensation entity to the organic chain previously grafted to the support which may or may not have been activated at ambient temperature and in an ethanol medium, and
− co-ordinating the metal derivative on the ligand by means of immersion in a solution of ethanol at ambient temperature in an inert atmosphere.

13. Oxygen-detecting and/or -absorbing device, characterised in that
it comprises a reactive compound according to any one of claims 1 to 12.
